(19) United States
(12) Patent Application Publication
(10) Pub. No.: US 2025/0029115 A1
(43) Pub. Date: Jan. 23, 2025

(54) SYSTEM AND METHOD FOR PROVIDING AN AI SALESPERSON

(71) Applicant: Ethan John Petroka, Sarasota, FL (US)

(72) Inventor: Ethan John Petroka, Sarasota, FL (US)

(21) Appl. No.: 18/630,390

(22) Filed: Apr. 9, 2024

Related U.S. Application Data
(60) Provisional application No. 63/528,114, filed on Jul. 21, 2023.

(51) Int. Cl. G06Q 30/016; G10L 13/033; G10L 15/22; G10L 15/30

(52) U.S. Cl. CPC G06Q 30/016; G10L 13/033; G10L 15/22; G10L 15/30

(57) ABSTRACT

A system and method for automating sales and support interactions using computerized agents that are customized based on attributes of a target customer/buyer is disclosed. An artificial intelligence salesperson (AIS) utility/module collects/retrieves activities and attributes information about a target customer to generate a custom AIS that can be used to communicate on a sales call or a technical support call with the customer. The AIS is designed to substantially emulate a real person to better communicate with the target customer. The AIS can change on the fly for each caller, learn from sighs audible expressions of the target customer, and react to emotional changes of target customers. To create the AIS, the AI module modifies an existing speech pattern, and/or creates its own speech patterns in real time, before passing the new and/or modified scripts to the voice engine, which then “speaks” on a call to the target customer.

### FIELD OF THE INVENTION

This application claims the benefit of U.S. Provisional Application No. 63/528,114 filed on Jul. 21, 2023. The present invention relates generally to intelligent automated agents, and more particularly, to sales and support calls servicing using intelligent automated agents.

### BACKGROUND OF THE INVENTION

Many organizations have been integrating automated customer service into their customer service in order to provide more efficient, faster, and cheaper assistance to their customers. Automated customer service can provide service 24 hours a day, which can, at least, complement face-to-face customer service. Additionally, automated services become less expensive over time, helping to provide services to more customers for a fraction of the cost of employees' wages. Thus, automation can be utilized to facilitate customer service which includes human agent customer service. However, in some cases, automated customer service may be used to replace human agent customer service entirely.

A popular type of automated customer service is done through artificial intelligence (AI). The customer benefit of AI is the feel for chatting with a live agent through improved speech technologies while giving customers the self-service benefit. Examples of customer service by artificial means are automated online assistants that can be seen as avatars on websites, which enterprises can use to reduce operating and training costs. These are driven by chatbots, and a major underlying technology to such systems is natural language processing.

A chatbot or chatterbot is a software application used to conduct an online chat conversation via text or text-to-speech, in lieu of providing direct contact with a live human agent. Chatbots are computer programs that are capable of maintaining a conversation with a user in natural language, understanding their intent, and replying based on preset rules and data.

Chatbots can efficiently conduct a dialogue, usually replacing other communication tools such as email, phone, or SMS. In banking, their major application is related to quick customer service answering common requests, as well as transactional support.

Despite AI's unmistakable capabilities in modernizing customer experience, one of the biggest mistakes that companies make in merging AI with customer service is that they carelessly integrate AI into customer service and treat consumers as numbers on a spreadsheet. As a result, customers are left with hollow experiences that are unhelpful, artificial, and unsatisfactory.

Ideally, it would be extremely useful to be able to have a customer service system that quickly and efficiently provides customers with the information and help they need. In addition, the customer service system should provide users with a personalized experience rather than a robotic experience.

Accordingly, there is need for a versatile and flexible solution that relies on the advances in information technology to efficiently provide customer service with a personalized approach while satisfying customers with the service provided.

### SUMMARY OF THE INVENTION

The present invention is directed to a method, a system and a computer program product for automating sales and support interactions using computerized agents that are customized based on attributes of a target customer/buyer. An artificial intelligence salesperson (AIS) utility/module collects/retrieves activities and attribute information about a target customer in order to generate a custom AIS that can be used to communicate on a sales call or a technical support call with the customer. The activities and attribute information which is received by an AI module collectively include web browsing history, page movements, social media information, phone number information, address information, gender, ethnicity, religion and/or various other types of personal attributes that may be relevant to the call. The AIS closely mimics a real person in order to better communicate with the target customer. To create the AIS, the AI module modifies an existing speech pattern/script, and/or creates its own speech patterns/scripts in real time, before passing the new and/or modified scripts to the voice engine, which then “speaks” on a call to the target customer. Moreover, the AI module can formulate different speech patterns in real time to make sales calls. According to one or more aspects, the AI module learns from previous sales from a specific customer and can adapt to new situations to provide a custom approach to a potential sales or business transaction.

According to an aspect, the AIS communicates in a manner that is substantially indistinguishable from a real person and relies on the information about the target customer to be able to change its gender or voice to match attributes of a friend, relative, or neighbor in order to better relate to the target customer.

According to an aspect, the AIS is able to change on the fly for each caller and, learn from sighs audible expressions of the target customer, and react to emotional changes of target customers.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 illustrates a block diagram representation of an example data processing system within which certain features of the present disclosure can be implemented, according to one or more embodiments;

FIG. 2 illustrates a computer and communications network 200 for enabling a server to gather and track first and third party customer data to generate an artificial intelligence salesperson to communicate with target customers on sales and support calls, according to one or more embodiments of the disclosure;

FIG. 3 presents a block diagram representation of a process and communication flow involving an artificial intelligence (AI) module that gathers customer data and communicates via a voice engine with customers on calls initiated and calls received by the AI module, according to one or more embodiments;

FIG. 4 presents a flow chart illustrating the process of providing an automated sales agent for communicating with a customer on a sales or support call, according to one or more embodiments;

FIG. 5 presents a flow chart illustrating the process of providing an artificial intelligence salesperson (AIS) that communicates with a target customer using custom scripts, according to one or more embodiments; and

FIG. 6 presents a flow chart illustrating the process of generating an AIS having a selected persona and utilizing a custom business/sales/transacting approach based on attribute information about a target customer and previous sales interactions/calls with the target customer, according to one or more embodiments.

Like reference numerals refer to like parts throughout the several views of the drawings.

### DETAILED DESCRIPTION

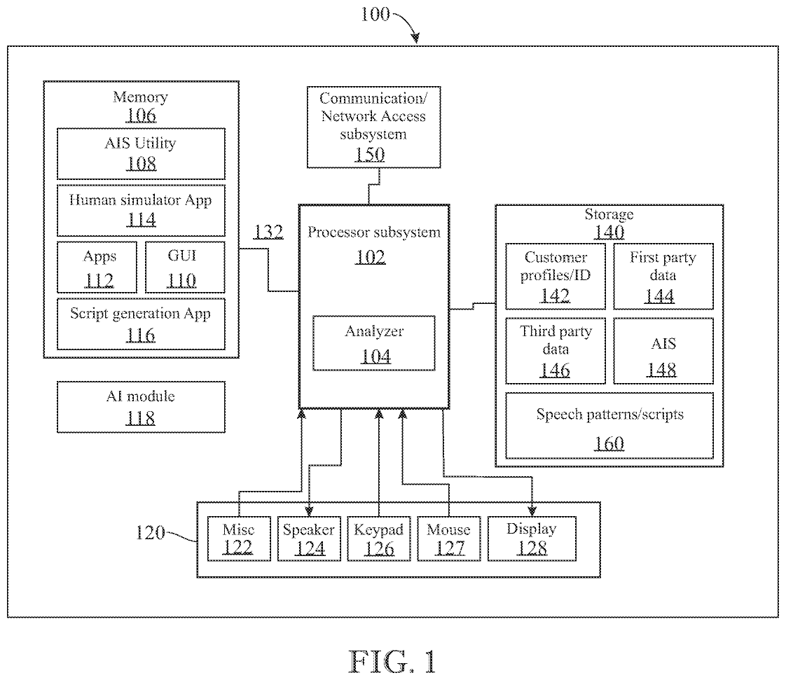

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Shown throughout the figures, the present disclosure is directed toward automating sales and support interactions using computerized agents that are customized based on attributes of a customer.

With reference now to the figures, and beginning with FIG. 1, there is depicted a block diagram representation of an example data processing system (DPS), as utilized within one embodiment. DPS may be a server, a digital audio workstation, a personal computer, a portable device, such as a personal digital assistant (PDA), a smart phone, and/or other types of electronic devices that may generally be considered processing devices or computing systems/devices. As illustrated, DPS 100 comprises at least one processor subsystem 102 connected to system memory 106 via system interlink/bus 132. DPS 100 executes one or more computer programs/applications to automate sales and support interactions using computerized agents that are customized based on attributes of a target customer, according to the present disclosure.

In one or more embodiments, data processing device 100, which is managed by processor subsystem 102, also includes communication subsystem 150, data storage subsystem 140, and input/output (I/O) subsystem 120. As shown, processor subsystem 102 includes an analyzer module 104 to support the data analysis functionality of DPS 100. Processor subsystem 102 executes program code to provide operating functionality of data processing device 100. The software and/or firmware modules have varying functionality when their corresponding program code is executed by processor subsystem 102 or secondary processing devices (not explicitly shown) within DPS 100.

As illustrated, I/O subsystem 120 includes user interface devices including output devices such as audio output device(s)/speaker 124, and display device 128. In one or more implementations, display device 128 includes touch screen functionality enabling display device to function as both an input device and an output device. In addition, I/O subsystem 120 includes input devices including microphone 122, keypad 126 and mouse 127.

Processor subsystem 102 is communicatively coupled, via system bus/interlink 132, to device memory 106. In one or more embodiments, processor subsystem 102 is communicatively coupled via system interlink 132 to communication subsystem 150, data storage subsystem 140, and input/output subsystem 120. System interlink 132 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components.

Communication subsystem 150 may be configured to enable DPS 100 to communicate with a plurality of personal computing devices. The communication subsystem may include wired and/or wireless communication devices to facilitate networked communication. Communication subsystem 150 also includes a Network Access Module by which DPS 100 may connect to one or more access/external networks such as the Internet or wide area network (WAN), or an internal network such as an Ethernet (local area network—LAN) or a Virtual Private Network (VPN).

In addition to the above described hardware components of DPS 100, various features of the invention are completed/supported via software (or firmware) code or logic stored within memory 106 or other storage and executed by Processor subsystem 102. Thus, for example, illustrated within memory 106 are a number of software/firmware/logic components, including human simulator application 114 and other applications 112. In addition, memory 106 comprises an Artificial Intelligence Salesperson (AIS) module/logic/utility 108. Device memory 106 further includes an operating system (OS) (not shown), a firmware interface, such as basic input/output system (BIOS) or Uniform Extensible Firmware Interface (UEFI), and firmware (not shown). Device memory 106 includes a graphical user interface (GUI) 110, a script generation application 116, and/or other computer data (not explicitly shown) used by the AIS utility 108 and/or the script generation application 116.

Data storage subsystem 140 enables further storage and retrieval of data, instructions, and code. In particular, data storage subsystem 140 provides applications, program code, and stored data on nonvolatile storage that is accessible by processor subsystem 102. For example, data storage subsystem 140 can provide, for use by the AIS utility 108, the customer profiles/identification (ID) 142, first-party data 144, third-party data 146, AIS 148, and speech patterns/scripts 160. In addition, data storage subsystem 140 can provide a selection of program code and applications such as the script generation application 116, and other related application(s) that can be used to automate sales and support interactions using computerized agents that are customized based on attributes of a target customer. These applications can be loaded into device memory 106 for execution by processor subsystem 102.

In actual implementation, the AIS logic 108 may be combined with the script generation application 116 to provide a single executable component, collectively providing the various functions of each individual component when the corresponding combined component is activated. For simplicity, the AIS logic/utility 108 is illustrated and described as a stand-alone or separate logic/firmware component, which provides specific functions, as described below.

In one embodiment, DPS 100 communicates with a software deploying server (not shown) via a network (e.g., the Internet) using communication subsystem/network access module 150. Then, AIS utility 108 may be deployed from/on the network, via the software deploying server. With this configuration, the software deploying server performs all of the functions associated with the execution of AIS utility 108. Accordingly, DPS 100 is not required to utilize internal computing resources of DPS 100 to execute AIS utility 108.

The AIS utility 108 automates sales and support interactions using computerized agents that are customized based on attributes of a target customer. According to one or more aspects, the AIS is configured to guide callers through an online sales or support process by which the AIS can tell a caller where to click and what to enter.

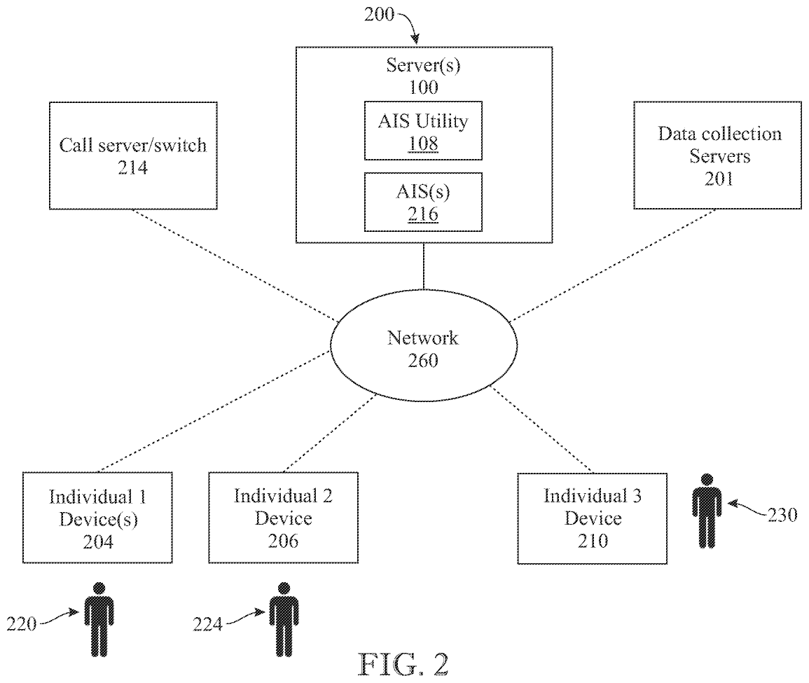

Certain of the functions supported and/or provided by the AIS utility/module 108 are implemented as processing logic (or code) executed by processor subsystem 102 and/or other device hardware, which processing logic enables the device to implement/perform those function(s). Among the software code/instructions/logic provided by the AIS module 108, and which are specific to the disclosure, are: (a) logic for identifying a target buyer/customer with whom to interact via an artificial intelligence salesperson (AIS) on a sales or technical support call; (b) logic for collecting/retrieving activities and attribute information about the target customer; (c) logic for extract, from received activities and attribute data, relevant customer data usable for sales/support call with the target customer; (d) logic for utilizing extracted/relevant customer data to modify existing scripts or speech patterns and/or to generate new scripts or speech patterns in real-time; (e) logic for generating a custom AIS that can be used to communicate on a sales call or a technical support call with the target customer; (f) logic for enabling the AIS to receive a call from or make a call to the target customer; (g) logic for providing scripts to a voice engine; and (h) logic for speaking via the voice engine with the target customer by closely mimicking a real person. According to the illustrative embodiment, when Processor subsystem 102 executes the AIS logic/module 108, DPS 100 initiates a series of functional processes that enable the above functional features as well as additional features/functionality. These features/functionalities are described in greater detail below within the description of FIGS. 2-6.

Those of ordinary skill in the art will appreciate that the hardware components and basic configuration depicted in FIG. 1 may vary. The illustrative components within DPS 100 are not intended to be exhaustive, but rather are representative to highlight essential components that are utilized to implement the present disclosure. For example, other devices/components may be used in addition to or in place of the hardware depicted. The depicted example is not meant to imply architectural or other limitations with respect to the presently described embodiments and/or the general disclosure.

Referring now to FIG. 2, a computer and communications network 200 for enabling a server to gather and track first and third party customer data to generate an artificial intelligence salesperson to communicate with target customers on sales and support calls, according to one or more embodiments of the disclosure. As illustrated in the computer and communication network 200, a number of computing/electronic devices are included. These computing devices, which can be similarly configured to DPS 100 (FIG. 1), include one or more servers 100. In addition, the network 200 includes a data collections server 201 for collecting customer data, and a call and switch server 214. According to one or more aspects, the server 100, the data collections server 201 and the call/switch server 214 collectively represent a customer service/support center. Additionally, the network 200 includes a first individual's device(s) 204, individual-2 device 206, and individual-3 device 210. The various computing devices are connected by a network 260. The network 260 can be any of the various networks, including a LAN or a WAN/Internet, described in FIG. 1.

According to an aspect, the network 260 can be a combination of networks which can include one or more of a private or public switched telephone network (PSTN), a cellular network, a LAN, a WAN/Internet, and any future generation public communication network.

According to an aspect, the call/switch server 214 is coupled to the network 260 for receiving and transmitting calls between individual users and the customer service support center. The call/switch server 214 may include a telephony switch configured to function as a central switch for call routing among automated customer service agents and/or human customer service agents within the customer service center. According to an aspect, the switch/server 214 may serve as an interface between the switch and the remainder of the routing, monitoring, and other call-handling systems of the customer service support center.

According to one or more aspects, the customer service support center may include a number of web servers such as social networking/media site hosts.

The computer network 200 allows customer profiles/IDs, first and third party data 144 and 146, and scripts 160 to be shared among servers 100. In addition, the computer network 200 allows the AIS(s) deployed by one or more servers 100 to communicate with customers utilizing the individual devices 204/206/210. Additionally, the AIS utility/module 108 can download the same or different configuration and control information to the various server devices, respectively.

According to one or more aspects, and as illustrated in FIG. 2, individual-1 220, individual-2 224 and individual-3 230 with their respective devices are shown within the computer and communication network 200. The individuals (i.e., individual-1 220, individual-2 224 and individual-3 230) represent customers or prospective buyers. According to one or more aspects, the individual devices 204/206/210 include a personal/laptop/tablet computer and a smart-phone.

According to one or more aspects, the AIS module 108 automates sales and support interactions using computerized agents that are customized based on attributes of a target customer/buyer 220. The AIS utility/module 108 collects/retrieves activities and attribute information about a target customer 220 in order to generate a custom AIS 216 that can be used to communicate on a sales call or a technical support call with the target customer 220.

The AIS module 108 collectively receives activities and attribute information in the form of web browsing history, page movements, social media information, phone number information, address information, as well as information about gender, ethnicity, religion and/or various other types of personal attributes that may be relevant to the call.

According to one or more aspects, the AIS module 108 can choose from among various attributes about an individual in order for these selected attributes to be factored into a communication style or other aspects of the call. According to an implementation, the AIS module 108 can choose from among hundreds of personal attributes that are factored into the call.

According to one or more aspects, the AIS module 108 collects information about an individual by searching for and locating (i) member profiles on social media platforms such as Facebook, Twitter, Instagram, and/or (ii) content creator channels hosted on platforms such as YouTube. The AIS module 108 collects information from social media platforms and/or content creator platforms for the purposes of obtaining a voice sample from content created or produced by the individual themselves. Additionally, or alternatively, the AIS module 108 may obtain a voice sample from content created or produced by a close friend or relative of the target individual.

According to one or more aspects, the AIS module 108 utilizes voice samples for the purposes of further tailoring the tonality and accent produced by the voice engine before initiating/answering a call to/from the target individual.

According to an aspect, the AIS 216 closely mimics (i.e., substantially emulates) a real person in order to provide enhanced communication with the target customer 220. The AIS 216 is able to change on the fly for each caller/customer 220, learn from sighs and audible expressions of the target customer 220, and react to emotional changes of the target customer 220.

In order to create the AIS 216, the AIS module 108 modifies an existing speech pattern/script, and/or creates its own speech patterns/scripts in real time, before passing the new and/or modified scripts to the voice engine, which then “speaks” on a call to the target customer 220. The AIS module 108 can formulate different speech patterns in real time to make sales calls. According to one or more aspects, the AIS module 108 learns from previous sales from a specific customer 220 and can adapt to new situations to provide a custom approach to a potential sales or business transaction.

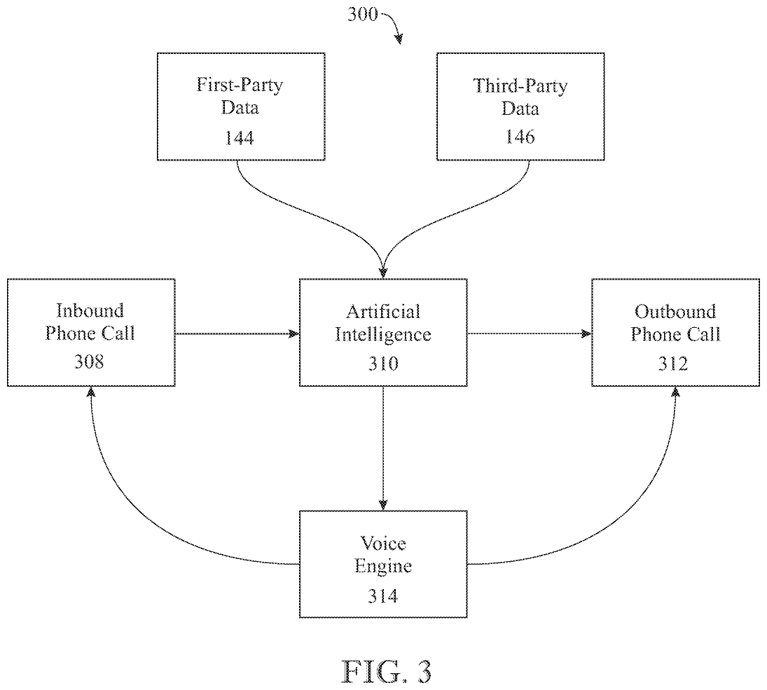

FIG. 3 presents a block diagram representation of a process and communication flow involving an artificial intelligence (AI) module that gathers customer data and communicates via a voice engine with customers on calls initiated and calls received by the AI module, according to one or more embodiments of the disclosure. The flow 300 is centered on an artificial intelligence (AI) module 310 which is connected to a voice engine 314. As illustrated in the flow 300, first party data 144 and third party data 146 are obtained/received by the AI module 310.

According to one or more aspects, the AI module 310 is configured to receive inbound phone calls 308 and process speech from an individual such as a buyer or customer that initiated the inbound call 308. The AI module 310 creates speech patterns or scripts and utilizes the scripts to communicate on the call with the buyer/customer by using the voice engine 314.

Similarly, according to one or more aspects, the AI module 310 is configured to make/initiate outbound phone calls 312 to a buyer or target customer. The AI module 310 creates speech patterns or scripts and utilizes the scripts to communicate on the call with the buyer/customer by using the voice engine 314. The AI module 310 is configured to process speech from the buyer/customer to whom the outbound call 312 was made. Additionally, the AI module is configured to provide appropriate personalized responses to the buyer/customer based on the content of the buyer's/customer's speech.

According to one or more aspects, the AI module 310 receives first party data representing activities and behavior data including one or more of past web browsing history, present web browsing history, personally identifiable information provided by the target customer, and on-page movements data.

According to one or more aspects, the AI module 310 receives third party data associated with the target customer/individual. According to one or more aspects, the third party data represent attribute data which can include direct or indirect assertions or implications about one or more of a person's gender, race, ethnicity, religion, beliefs, age, sexual orientation or practices, gender identity, disability, physical or mental health (including medical conditions), vulnerable financial status, voting status, membership in a trade union, and criminal record.

The AI module 310 extracts from the received first and third party data relevant information usable with respect to a current or future or imminent sales/service call with the target customer 220 and utilizes the extracted/relevant customer data to modify existing scripts or speech patterns and/or to generate new scripts or speech patterns in real-time.

According to one or more aspects, the AIS module 108 can generate filler words such as “uh” “um” “like”, etc., at appropriate moments to further mimic real life speech.

According to one or more aspects, if the AIS module 108 has access to and/or has obtained only limited information about the individual, the AIS module 108, at the time of the call, can resort to utilizing a default voice that sounds very much like a real human voice. Furthermore, the AIS module 108 can provide a default voice that has no obvious accent or ethnic bias.

According to one or more aspects, the AI module 310 communicates/speaks via a voice engine 314 using the scripts with the target customer 220.

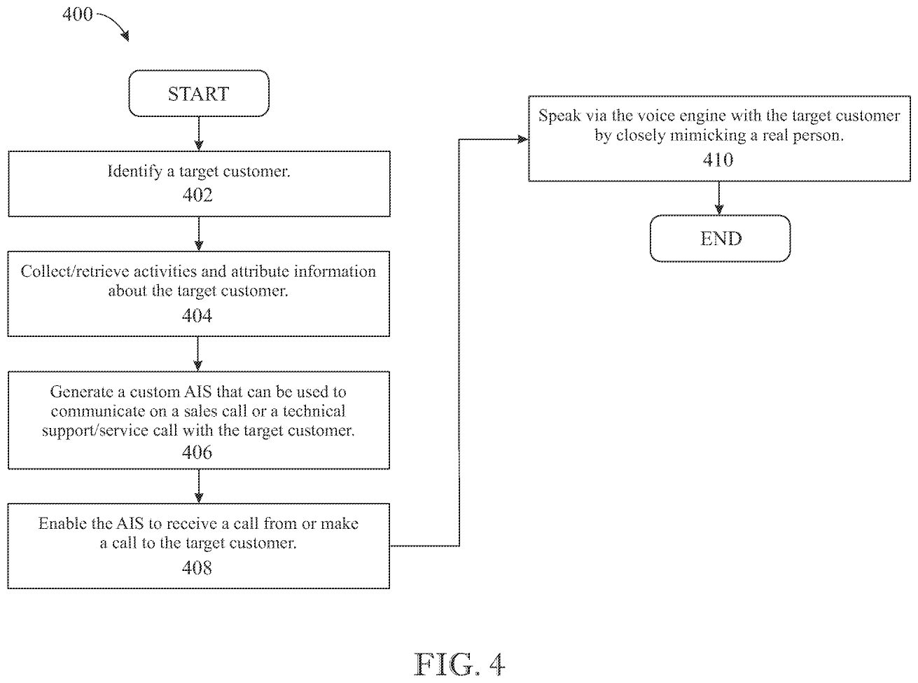

FIGS. 4-6 are flow charts illustrating various methods by which the above process of the illustrative embodiments is completed. Although the methods illustrated in FIGS. 4-6 may be described with reference to components shown in FIGS. 1-3, it should be understood that this is merely for convenience and alternative components and/or configurations thereof can be employed when implementing the various methods. Key portions of the methods may be completed by the Artificial Intelligence Salesperson (AIS) module 108 executing on processor subsystem 102 within DPS 100 (FIG. 1) and controlling specific operations of/on DPS 100, and the methods are thus described from the perspective of either/both the AIS module 108 and DPS 100 or other device that provides the functionality associated with one or more versions of the AIS module 108.

FIG. 4 presents a flow chart illustrating the process of providing an automated sales agent for communicating with a customer on a sales or support call, according to one or more embodiments. The process of FIG. 4 begins at the initiator/start block and proceeds to block 402, at which the AIS module 108 identifies a target customer with whom to interact via an artificial intelligence salesperson (AIS) on a sales or technical support call.

At block 404, the AIS module 108 collects/retrieves activities and attribute information about the target customer, which the AIS module 108 uses to generate a custom AIS that can be used to communicate on a sales call or a technical support/service call with the target customer, as shown at block 406.

According to one or more aspects, in order to create the AIS 216, the AIS module 108 modifies an existing speech pattern/script, and/or creates its own speech patterns/scripts in real time, before passing the new and/or modified scripts to the voice engine, which then “speaks” on a call to the target customer 220. The AIS module 108 can formulate different speech patterns in real time to make sales calls. According to one or more aspects, the AIS module 108 learns from previous sales from a specific customer 220 and can adapt to new situations to provide a custom approach to a potential sales or business transaction.

At block 408, the AIS module 108 enables the AIS to receive from or make a call to the target customer. According to an aspect, the AIS module 108 triggers the AIS to speak via the voice engine with the target customer by closely mimicking a real person, as shown at block 410. The process proceeds to the end block.

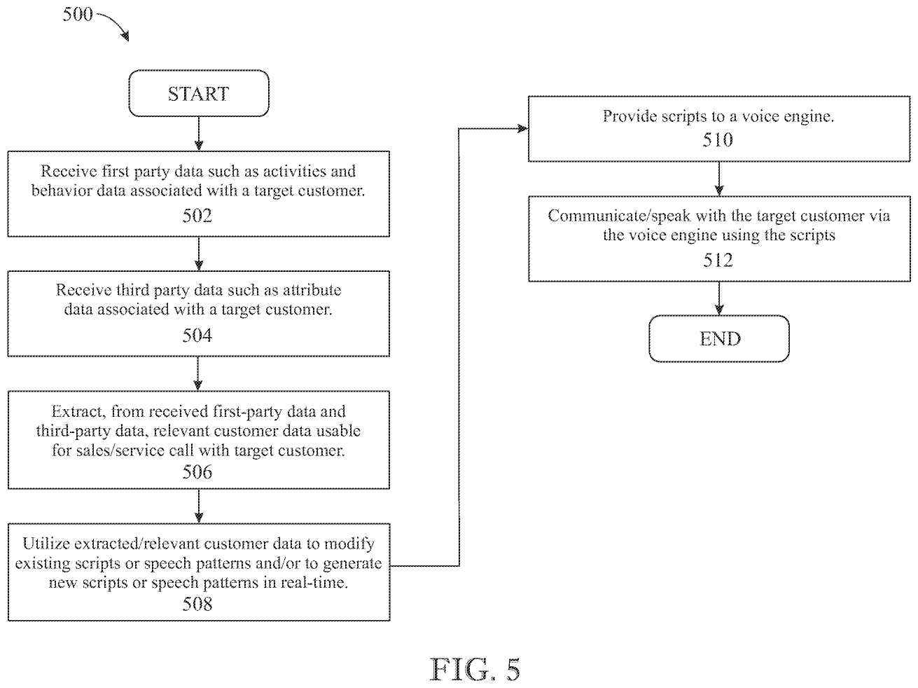

FIG. 5 presents a flow chart illustrating the process of providing an artificial intelligence salesperson (AIS) that communicates with a target customer using custom scripts, according to one or more embodiments. The process of FIG. 5 begins at the initiator/start block and proceeds to block 502, at which the AIS module 108 receives at an AI module first party data associated with a target customer/individual. According to one or more aspects, the first party data represent activities and behavior data and includes one or more of past web browsing history, present web browsing history, personally identifiable information provided by the target customer, and on-page movements data.

At block 504, the AIS module 108 receives at the AI module third party data associated with the target customer/individual. According to one or more aspects, the third party data represent attribute data which can include direct or indirect assertions or implications about one or more of a person's gender, race, ethnicity, religion, beliefs, age, sexual orientation or practices, gender identity, disability, physical or mental health (including medical conditions), vulnerable financial status, voting status, membership in a trade union, and criminal record.

The AIS module 108 extracts from the received first and third party data relevant information usable with respect to a current or future or imminent sales/service call with the target customer, as shown at block 506.

At block 508, the AIS module 108 utilizes the extracted/relevant customer data to modify existing scripts or speech patterns and/or to generate new scripts or speech patterns in real-time. The AIS module 108 transmits the new and/or modified scripts to a voice engine, as shown at block 510.

According to one or more aspects, the AIS module 108 communicates/speaks via the voice engine using the scripts with the target customer on the other end of the phone line/connection, as shown at block 512.

According to one or more aspects, the AIS module 108 is configured to initiate phone calls to a target customer as well as receive phone calls from the target customer, respectively. The process proceeds to the end block.

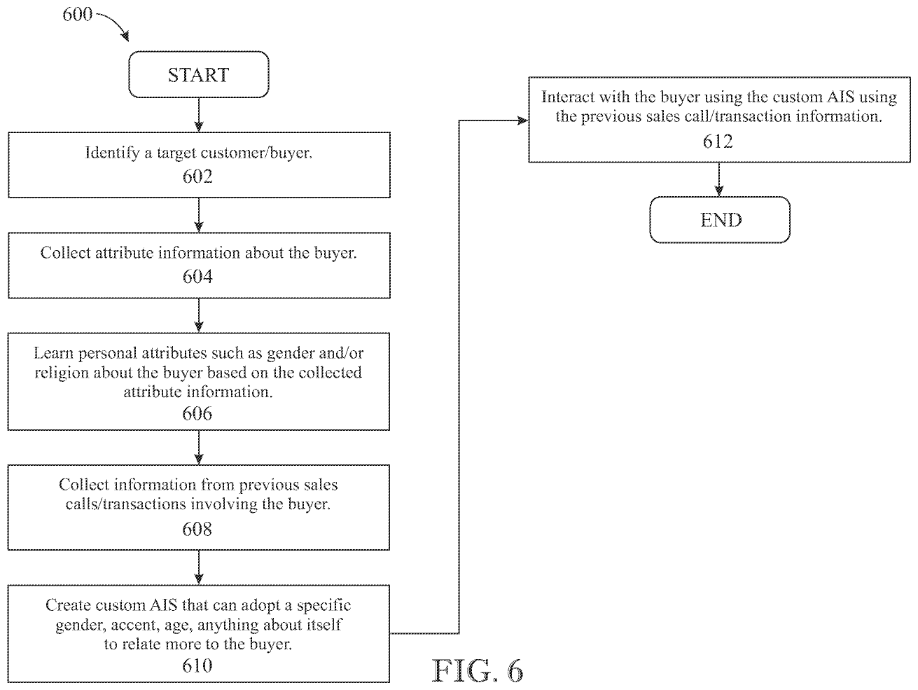

FIG. 6 presents a flow chart illustrating the process of generating an AIS having a selected persona and utilizing a custom business/sales/transacting approach/process based on attribute information about a target customer and previous sales interactions/calls with the target customer, according to one or more embodiments. The process of FIG. 6 begins at the initiator/start block and proceeds to block 602, at which the AIS module 108 identifies a target customer/buyer with whom a current call is takes place or an imminent call will occur.

At block 604, the AIS module 108 collects attribute information about the buyer. In particular, the attribute data which is referred to as third-party data can include direct or indirect assertions or implications about one or more of a person's gender, race, ethnicity, religion, beliefs, age, sexual orientation or practices, gender identity, disability, physical or mental health (including medical conditions), vulnerable financial status, voting status, membership in a trade union, and criminal record.

At block 606, the AIS module 108 is able to learn personal attributes about the buyer based on the collected attribute information.

According to one or more aspects, the AIS module 108 collects information from previous sales calls/transactions involving the target customer/buyer, as shown at block 608.

At block 610, the AIS module 108 creates a custom AIS 216 that can adopt a specific gender, accent, age, anything about itself to relate more to the buyer. According to one or more aspects, in order to create the AIS 216, the AIS module 108 modifies an existing speech pattern/script, and/or creates its own speech patterns/scripts in real time, before passing the new and/or modified scripts to the voice engine, which then “speaks” on a call to the target customer 220. The AIS module 108 can formulate different speech patterns in real time to make sales calls.

Additionally, the AIS module 108 utilizes the custom AIS to interact with the target customer/buyer using the previous sales call/transaction information, as shown at block 612. The process proceeds to the end block.

A method, a system and a computer program product for automating sales and support interactions using computerized agents that are customized based on attributes of a target customer/buyer is disclosed. An artificial intelligence salesperson (AIS) utility/module collects/retrieves activities and attribute information about a target customer in order to generate a custom AIS that can be used to communicate on a sales call or a technical support call with the customer. The activities and attribute information which is received by an AI module collectively include web browsing history, page movements, social media information, phone number information, address information, gender, ethnicity, religion and/or various other types of personal attributes that may be relevant to the call. The AIS closely mimics a real person in order to better communicate with the target customer. To create the AIS, the AI module modifies an existing speech pattern/script, and/or creates its own speech patterns/scripts in real time, before passing the new and/or modified scripts to the voice engine, which then “speaks” on a call to the target customer. Moreover, the AI module can formulate different speech patterns in real time to make sales calls. According to one or more aspects, the AI module learns from previous sales from a specific customer and can adapt to new situations to provide a custom approach to a potential sales or business transaction.

According to an aspect, the AIS communicates in in manner that is substantially indistinguishable from a real person and relies on the information about the target customer to be able to change its gender or voice to match attributes of a friend, relative, or neighbor in order to better relate to the target customer.

According to an aspect, the AIS is able to change on the fly for each caller and learn from sighs, audible expressions of the target customer, and react to emotion changes of target customers.

According to one or more aspects, the AIS enhances customer service while providing a healthy dose of personal, human touch. Furthermore, the AIS automated utilizes historical customer data to optimize the language, tone, and support aspects of customer service.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A computerized method for automating sales and support interactions with a target customer, comprising the steps of:
collecting data information about the target customer;
generating scripts and speech patterns based on the collected data information;
providing a custom AIS module that can utilize the scripts and speech patterns to communicate on a sales call or a technical support call with the target customer;
enabling the AIS module to communicate with the target customer; and
triggering the AIS module to speak via a voice engine with the target customer by substantially emulating a human's speech pattern while vocalizing the scripts and speech patterns.

2. The method of claim 1, wherein the AIS module is configured to implement filler words in the scripts and speech patterns.

3. The method of claim 1, wherein the scripts and speech patterns spoken by the voice engine of the AIS module are modifiable in real-time by the AIS module as the AIS module collects additional data information on the target customer.

4. The method of claim 1, wherein the AIS module obtains personal identifiable information about the target customer from a first party data source.

5. The method of claim 4, wherein the first party data source includes online browsing activity of the target customer.

6. The method of claim 1, wherein the AIS module obtains personal identifiable information about the target customer from a third party data source.

7. The method of claim 6, wherein the third party source includes representative data about the target customer.

8. The method of claim 7, wherein representative data includes gender, race, ethnicity, religion, beliefs, age, sexual orientation or practices, gender identity, disability, physical or mental health, medical conditions), vulnerable financial status, voting status, membership in a trade union, or criminal record.

9. The method of claim 1, wherein the AIS module is configured to initiate outbound calls to the target customer.

10. The method of claim 1, wherein the AIS module utilizes voice samples to modify tonality and accent of the speech scripts and patterns generated by the voice engine.

11. The method of claim 1, wherein the AIS module communications with third party applications to collect voice sample information on the target customer.

12. The method of claim 11, wherein third party applications include social media applications that include generated media by the targeted customer that includes voice samples of the targeted customer.

13. A computerized method for automating sales and support interactions with a target customer, comprising the steps of:
providing an AIS module comprising,
a data processing system including a processor connected to memory and capable of executing one or more commands,
a processor subsystem communicatively coupled to a communication subsystem, data storage subsystem, input or output subsystem, and a system interlink,
an analyzer application executing one or more commands to analyze one or more data information and generate an output, and
the communication subsystem including a communication module for enabling communication of the AIS module with one or more electronic devices,
wherein the AIS module includes an application capable of executing one or more commands comprising storage and retrieval of data from memory and executing of instructions based on learning models;
identifying the target customer through the data processing system;
collecting data information about the target customer enabled by the communication subsystem;
generating scripts and speech patterns based on the data information using the analyzer application;
utilizing the scripts and speech patterns to communicate on a sales call or a technical support call with the target customer; and
triggering the AIS module to speak via a voice engine with the target customer that vocalizes the scripts and speech patterns in a tone that substantially emulates a human's speech pattern.

14. The method of claim 13, wherein the AIS module is configured to implement filler words in the scripts and speech patterns.

15. The method of claim 13, wherein the scripts and speech patterns spoken by the voice engine of the AIS module are modifiable in real-time by the AIS module as the AIS module collects additional data information on the target customer.

16. The method of claim 13, wherein the AIS module receives personal identifiable information about the target customer from a first party data source.

17. The method of claim 16, wherein the first party data source includes online browsing activity of the target customer.

18. The method of claim 13, wherein the AIS module receives personal identifiable information about the target customer from a third party data source.

19. The method of claim 13, wherein the AIS module utilizes voice samples to modify tonality and accent of the speech scripts and patterns generated by the voice engine.

20. A computerized method for automating sales and support interactions with a target customer, comprising the steps of:
providing an AIS module comprising,
a data processing system including a processor connected to memory and capable of executing one or more commands,
a processor subsystem communicatively coupled to a communication subsystem, data storage subsystem, input or output subsystem, and a system interlink,
an analyzer application executing one or more commands to analyze one or more data information and generate an output, and
the communication subsystem including a communication module for enabling communication of the AIS module with one or more electronic devices,
wherein the AIS module includes an application capable of executing one or more commands comprising storage and retrieval of data from memory and executing of instructions based on learning models;
identifying the target customer through the data processing system;
collecting data information about the target customer enabled by the communication subsystem from a first party data source and a third party data source,
wherein the first party data source includes online browsing activity of the target customer, and
wherein the third party data source includes social media applications that includes representative data about the target customer;
generating scripts and speech patterns based on the data information using the analyzer application;
utilizing the scripts and speech patterns to communicate on a sales call or a technical support call with the target customer; and
triggering the AIS module to speak via a voice engine with the target customer that vocalizes the scripts and speech patterns in a tone that substantially emulates a human's speech pattern.
